(19) United States
(12) Patent Application Publication
(10) Pub. No.: US 2013/0253809 A1
(43) Pub. Date: Sep. 26, 2013

(54) COLLABORATIVE NEAR-MISS ACCIDENT REPORTING

(71) Applicants: Andrew R. Jones, Round Rock, TX (US); James Robert Kozloski, New Fairfield, CT (US); Brian Marshall O'Connell, RTP, NC (US); Clifford Alan Pickover, Yorktown Heights, NY (US)

(72) Inventors: Andrew R. Jones, Round Rock, TX (US); James Robert Kozloski, New Fairfield, CT (US); Brian Marshall O'Connell, RTP, NC (US); Clifford Alan Pickover, Yorktown Heights, NY (US)

(73) Assignee: International Business Machines Corporation, Armonk, NY (US)

(21) Appl. No.: 13/429,951

(22) Filed: Mar. 26, 2012

(51) Int. Cl. G01C 21/34; G08G 1/00

(52) U.S. Cl. 701/117

(57) ABSTRACT

Illustrative embodiments include a method, system, and computer program product for collaborative near-miss accident reporting. A computer receives, from a source among several sources, data relating to a near-miss accident. The computer determines whether the data relating to the near-miss accident is indicative of an event whose information should be distributed. The computer distributes, responsive to the determining being affirmative, near-miss accident information corresponding to the data relating to the near-miss accident.

### TECHNICAL FIELD

The present invention relates generally to a method, system, and computer program product for improved travel safety. Particularly, the present invention relates to a method, system, and computer program product for collaborative near-miss accident reporting.

### BACKGROUND

Global Positioning System (GPS) based navigation has proliferated travel operations, including day-to-day commuting. Vehicles have available either as an installed device or a portable accessory, a GPS device capable of navigating in a region using map data.

Some GPS devices can also receive broadcast traffic advisory information to recommend or alter a navigation route. Some GPS devices also allow a user to configure areas to avoid for navigation purposes. For example, a user can configure a GPS device to avoid toll-roads or certain geographical areas, generally, or during certain times.

### SUMMARY

In at least one embodiment, a method for collaborative near-miss accident reporting is provided. The method includes a computer receiving, from a source in a plurality of sources, data relating to a near-miss accident. The method further includes the computer determining whether the data relating to the near-miss accident is indicative of an event whose information should be distributed. The method further includes the computer distributing, responsive to the determining being affirmative, near-miss accident information corresponding to the data relating to the near-miss accident.

In at least one embodiment, a computer program product for collaborative near-miss accident reporting is provided. The computer program product includes one or more computer-readable tangible storage devices. The computer program product further includes program instructions, stored on at least one of the one or more storage devices, to receive, from a source in a plurality of sources, data relating to a near-miss accident. The computer program product further includes program instructions, stored on at least one of the one or more storage devices, to form a determination whether the data relating to the near-miss accident is indicative of an event whose information should be distributed. The computer program product further includes program instructions, stored on at least one of the one or more storage devices, to distribute, responsive to the determination being affirmative, near-miss accident information corresponding to the data relating to the near-miss accident.

In at least one embodiment, a computer system for collaborative near-miss accident reporting is provided. The computer system includes one or more processors and one or more computer-readable tangible storage devices. The computer system further includes program instructions, stored on at least one of the one or more storage devices for execution by at least one of the one or more processors, to receive, from a source in a plurality of sources, data relating to a near-miss accident. The computer system further includes program instructions, stored on at least one of the one or more storage devices for execution by at least one of the one or more processors, to form a determination whether the data relating to the near-miss accident is indicative of an event whose information should be distributed. The computer system further includes program instructions, stored on at least one of the one or more storage devices for execution by at least one of the one or more processors, to distribute, responsive to the determination being affirmative, near-miss accident information corresponding to the data relating to the near-miss accident.

In at least one embodiment, another method for collaborative near-miss accident reporting is provided. The method includes a computer in a vehicle receiving a set of inputs from instrumentation in the vehicle. The method further includes the computer determining whether the set of inputs is indicative of a near-miss accident. The method further includes the computer transmitting, responsive to the determining being affirmative, data relating to the near-miss accident to an aggregation system.

In at least one embodiment, another computer program product for collaborative near-miss accident reporting is provided. The computer program product includes one or more computer-readable tangible storage devices. The computer program product further includes program instructions, stored on at least one of the one or more storage devices, to receive a set of inputs from instrumentation in a vehicle. The computer program product further includes program instructions, stored on at least one of the one or more storage devices, to form a determination whether the set of inputs is indicative of a near-miss accident. The computer program product further includes program instructions, stored on at least one of the one or more storage devices, to transmit, responsive to the determination being affirmative, data relating to the near-miss accident to an aggregation system.

In at least one embodiment, another computer system for collaborative near-miss accident reporting is provided. The computer system includes one or more processors and one or more computer-readable tangible storage devices. The computer system further includes program instructions, stored on at least one of the one or more storage devices for execution by at least one of the one or more processors, to receive a set of inputs from instrumentation in a vehicle. The computer system further includes program instructions, stored on at least one of the one or more storage devices for execution by at least one of the one or more processors, to form a determination whether the set of inputs is indicative of a near-miss accident. The computer system further includes program instructions, stored on at least one of the one or more storage devices for execution by at least one of the one or more processors, to transmit, responsive to the determination being affirmative, data relating to the near-miss accident to an aggregation system.

### BRIEF DESCRIPTION OF THE SEVERAL VIEWS OF THE DRAWINGS

The novel features believed characteristic of the invention are set forth in the appended claims. The invention itself, however, including a preferred mode of use, further objectives and advantages thereof, will best be understood by reference to the following detailed description of illustrative embodiments when read in conjunction with the accompanying drawings, wherein:

FIG. 1 depicts a pictorial representation of a network of data processing systems in which illustrative embodiments may be implemented;

FIG. 2 depicts a block diagram of a data processing system in which illustrative embodiments may be implemented;

FIG. 3 depicts a block diagram of a generalized onboard configuration for collaborative near-miss accident reporting in accordance with an illustrative embodiment;

FIG. 4 depicts a block diagram of an example configuration of an aggregation system for collecting, processing, managing, and distributing near-miss accident information in accordance with an illustrative embodiment;

FIG. 5 depicts a block diagram of an example configuration of an onboard system in accordance with an illustrative embodiment;

FIG. 6 depicts a flowchart of an example process of near-miss accident detection in an onboard system in accordance with an illustrative embodiment;

FIG. 7 depicts a flowchart of an example process of collaborative near-miss accident reporting in accordance with an illustrative embodiment; and

FIG. 8 depicts a flowchart of an example process of managing near-miss accident information in accordance with an illustrative embodiment.

### DETAILED DESCRIPTION

The illustrative embodiments recognize that many hazardous conditions encountered while operating a vehicle have the potential to cause an accident. Through careful operation of the vehicle, operation of a vehicle's safety mechanism, or merely by chance, a hazardous condition may not actually result in an accident.

The illustrative embodiments further recognize that while one vehicle operator may avoid an accident, another operator may not be so lucky, or comparably equipped to avoid the accident. The illustrative embodiments also recognize that some hazardous conditions are transient, semi-permanent, or permanent, which can be avoided with suitable and timely knowledge. In an example of a vehicle, specifically a car, a transient hazardous condition may exist on a road due to debris on the road. Once the debris is cleared, the hazardous condition no longer persists. A semi-permanent hazardous condition may exist at a hairpin turn on winter nights when fog settles on the ground. A permanent hazardous condition may exist when the lanes of a highway narrow or merge suddenly.

The illustrative embodiments recognize that while accident reports are available through road-side displays or other sources, accidents that could have occurred but did not occur (near-miss accidents) are seldom reported. Furthermore, the information of a near-miss accident often remains with the vehicle operator who encountered the near-miss accident, and even if remembered, provides little or no benefit to other operators.

The illustrative embodiments recognize that if near-miss accident information can be shared with other persons, such as other operators, the rate of hazardous conditions translating into actual accidents can be reduced. The illustrative embodiments further recognize that the near-miss accident information can be used to assist or limit travel through areas where the near-miss accident incidents have occurred. For example, a parent can program a GPS device in a child's vehicle to avoid those areas where near-miss accidents have occurred recently. As another example, when a number of near-miss accidents are reported, police can be notified to proactively address the hazardous condition before an accident occurs.

The illustrative embodiments recognize that encountering a hazardous condition and determining that the events of the encounter warrant categorizing the events as a near-miss accident is non-trivial. The illustrative embodiments further recognize that upon recognizing a near-miss accident, compiling data suitable for warning others of the near-miss accident adds additional complexity over and above recognizing a near-miss accident. The illustrative embodiments recognize that even after the near-miss accident data is compiled, distributing near-miss accident information in a manageable and usable way poses additional problems in using near-miss accident information. The illustrative embodiments also recognize that determining whether the near-miss accident information should be retained for continued distribution is also a complex problem.

The illustrative embodiments used to describe the invention generally address and solve the above-described problems and other problems related to near-miss accidents. The illustrative embodiments provide a method, system, and computer program product for collaborative near-miss accident reporting.

Generally, an embodiment of the invention provides a technique for onboard collection of data in a vehicle about the events transpiring when the vehicle encounters a hazardous condition. An embodiment makes the determination whether the events qualify as a near-miss accident. If the events qualify as a near-miss accident, an embodiment compiles and transmits the near-miss accident data from an onboard system to an aggregation facility. An embodiment can also alert the vehicle operator or another person or entity about the near-miss accident.

An embodiment receives and verifies the near-miss accident data at an aggregation system. An embodiment categorizes, processes, stores, and distributes near-miss accident information based on received near-miss accident data. An embodiment manages the near-miss accident data collected over a period based on a determined usefulness of the corresponding near-miss accident information.

The illustrative embodiments are described with respect to certain data and information based thereon only as examples. Such descriptions are not intended to be limiting on the invention. For example, an illustrative embodiment described with respect to data received from one type of instrumentation in the vehicle can be implemented with similarly purposed data from another type of instrumentation in the vehicle within the scope of the illustrative embodiments.

Furthermore, the illustrative embodiments may be implemented with respect to any type of data, data source, or access to a data source over a data network. Any type of data application or storage device may provide the data, such as data for an application data packet or historical state information data, to an embodiment of the invention, either locally at a data processing system or over a data network, within the scope of the invention.

The illustrative embodiments are further described with respect to certain applications only as examples. Such descriptions are not intended to be limiting on the invention. For example, an embodiment described with respect to a GPS device in a surface-usable vehicle can be implemented using another application or device in an airborne vehicle within the scope of the illustrative embodiments.

An embodiment of the invention may be implemented with respect to any type of application, such as, for example, applications that are served, the instances of any type of server application, a platform application, a stand-alone application, an administration application, or a combination thereof. An application, including an application implementing all or part of an embodiment, may further include data objects, code objects, encapsulated instructions, application fragments, services, and other types of resources available in a data processing environment. For example, a Java® object, an Enterprise Java Bean (EJB), a servlet, or an applet may be manifestations of an application with respect to which the invention may be implemented. (Java and all Java-based trademarks and logos are trademarks or registered trademarks of Oracle Corporation and/or its affiliates).

An illustrative embodiment may be implemented in hardware, software, or a combination thereof. An illustrative embodiment may further be implemented with respect to any type of data storage resource, such as a physical or virtual data storage device, that may be available in a given data processing system configuration.

The examples in this disclosure are used only for the clarity of the description and are not limiting on the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting on the illustrative embodiments. Additional or different advantages may be realized by specific illustrative embodiments. Furthermore, a particular illustrative embodiment may have some, all, or none of the advantages listed above.

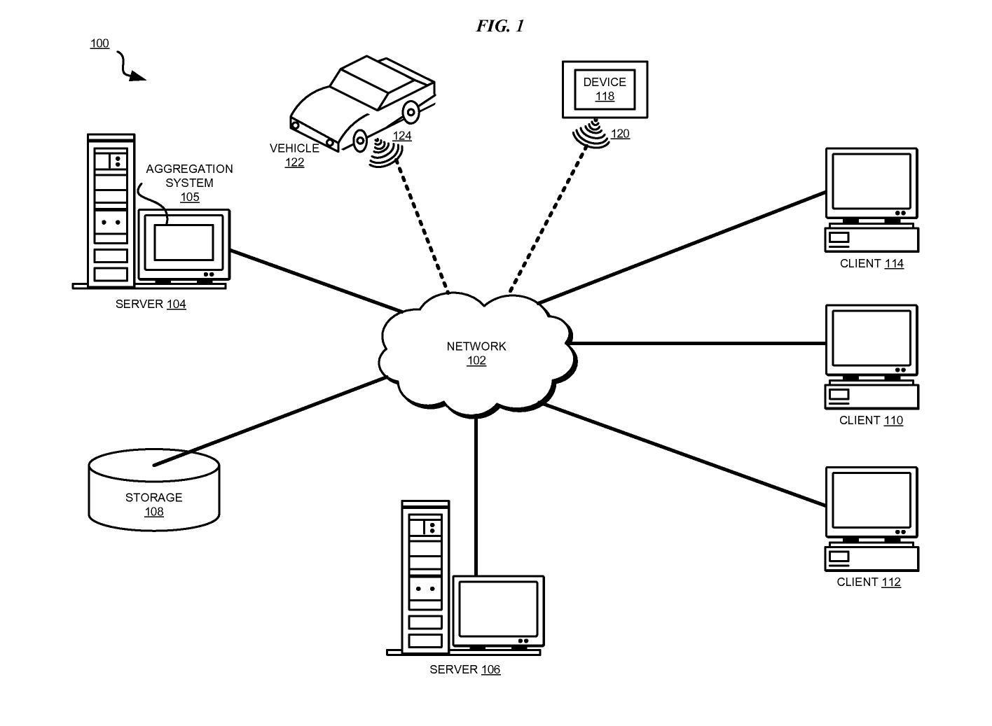

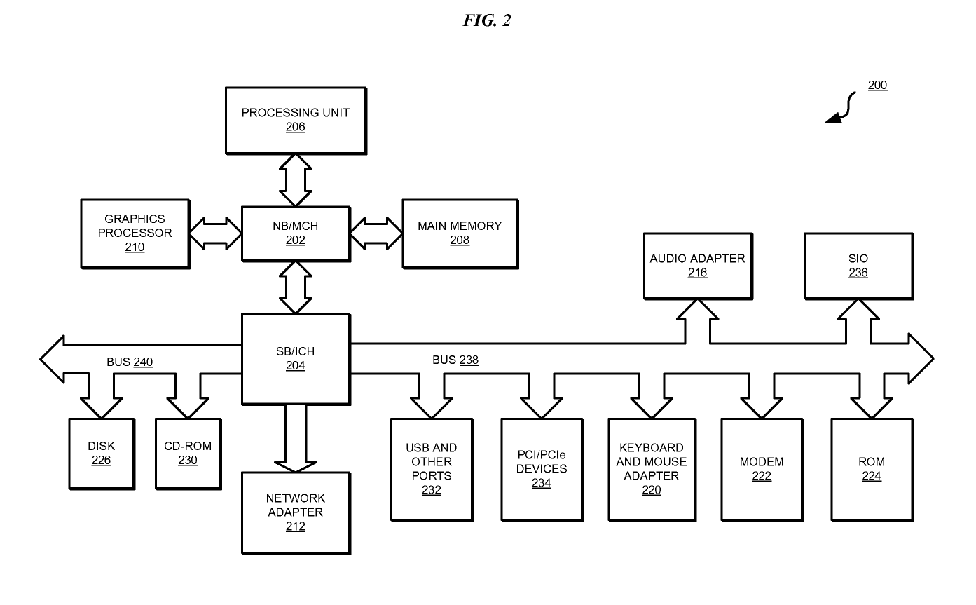

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a pictorial representation of a network of data processing systems in which illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables. Server 104 and server 106 couple to network 102 along with storage unit 108. Software applications may execute on any data processing system in data processing environment 100.

Clients 110, 112, and 114 also couple to network 102. A data processing system, such as server 104 or 106, or client 110, 112, or 114 may contain data and may have software applications or software tools executing thereon.

In addition, device 118 may be a GPS device associated with a vehicle. Device 118 is able to communicate with network 102 using wireless communication 120. Aggregation system 105 in server 104 is a system for collecting, processing, managing, and distributing near-miss accident information in accordance with an embodiment. Vehicle 122 is depicted as a car only as an example, and not as a limitation on the illustrative embodiments. Any vehicle of any type may be improved with an embodiment described herein. Vehicle 122 communicates with network 102 using some form of wireless communication. Wireless communication networks 120 and 124 may be common to device 118 and vehicle 122 in some circumstances, such as when device 118 is coupled with vehicle 122. The embodiments described herein describe the features and operations of an onboard system. The described onboard system can be formed using device 118, certain components of vehicle 122, or a combination thereof, without limitation, and depending on the particular implementation. The features of the onboard system of an embodiment can be implemented in device 118, certain components of vehicle 122, or a combination thereof, without limitation, and depending on the particular implementation.

In the depicted example, server 104 may provide data, such as boot files, operating system images, and applications to clients 110, 112, and 114. Clients 110, 112, and 114 may be clients to server 104 in this example. Clients 110, 112, 114, or some combination thereof, may include their own data, boot files, operating system images, and applications. Data processing environment 100 may include additional servers, clients, and other devices that are not shown.

Servers 104 and 106, storage unit 108, and clients 110, 112, and 114 may couple to network 102 using wired connections, wireless communication protocols, or other suitable data connectivity. For example, a cluster typically has multiple network types, such as IP networks, direct connections of machines via packets exchange implemented by storage protocols (Fibre Channel, SCSI), serial links, and message exchange via writing and reading packets to shared storage such as a hard disk drive. For performance reasons, in sending client traffic, an IP network is given precedence. Furthermore, a given network type may not connect to all nodes in a cluster. For instance, a cluster may span machines located at two geographically distant sites. For the long distance connection, Ethernet may be the preferred connection, and within a geographical location, a direct connection may be preferable. Additionally, within a geographical location, additional non-IP networks, such as Fibre channel or serial connections may be used within the scope of the illustrative embodiments.

Clients 110, 112, and 114 may be, for example, personal computers, network computers, thin clients, or industrial control systems. In the depicted example, server 104 may provide data, such as boot files, operating system images, and applications to clients 110, 112, and 114. Clients 110, 112, and 114 may be clients to server 104 in this example. Clients 110, 112, 114, or some combination thereof, may include their own data, boot files, operating system images, and applications. Data processing environment 100 may include additional servers, clients, and other devices that are not shown.

In the depicted example, data processing environment 100 may be the Internet. Network 102 may represent a collection of networks and gateways that use the Transmission Control Protocol/Internet Protocol (TCP/IP) and other protocols to communicate with one another, and encompasses components including but not limited to IP and SAN components. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), a wide area network (WAN), or mobile ad hoc network (MANET). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications.

With reference to FIG. 2, this figure depicts a block diagram of a data processing system in which illustrative embodiments may be implemented. Data processing system 200 is an example of a computer, such as server 104, server 106, or client 112 in FIG. 1, in which computer usable program code or instructions implementing the processes of the illustrative embodiments may be located for the illustrative embodiments. Data processing system 200 is also representative of device 118 in FIG. 1, in which computer usable program code or instructions implementing the processes of the illustrative embodiments may be located for the illustrative embodiments. Data processing system 200 is also representative of a data processing system embedded in vehicle 122 in FIG. 1, in which computer usable program code or instructions implementing the processes of the illustrative embodiments may be located for the illustrative embodiments. Data processing system 200 is described as a computer only as an example, without being limited thereto. Implementations in the form of device 118 or a data processing system embedded in vehicle 122 in FIG. 1 may modify data processing system 200 and even eliminate certain depicted components therefrom without departing from the general description of the operations and functions of data processing system 200 described herein.

In the depicted example, data processing system 200 employs a hub architecture including North Bridge and memory controller hub (NB/MCH) 202 and south bridge and input/output (I/O) controller hub (SB/ICH) 204. Processing unit 206, main memory 208, and graphics processor 210 are coupled to north bridge and memory controller hub (NB/MCH) 202. Processing unit 206 may include one or more processors and may be implemented using one or more heterogeneous processor systems. Graphics processor 210 may be coupled to NB/MCH 202 through an accelerated graphics port (AGP) in certain implementations.

In the depicted example, local area network (LAN) adapter 212 is coupled to south bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to south bridge and I/O controller hub 204 through bus 238. Hard disk drive (HDD) 226 and CD-ROM 230 are coupled to south bridge and I/O controller hub 204 through bus 240. PCI/PCIe devices 234 may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE) or serial advanced technology attachment (SATA) interface. A super I/O (SIO) device 236 may be coupled to south bridge and I/O controller hub (SB/ICH) 204 through bus 238.

An operating system runs on processing unit 206. The operating system coordinates and provides control of various components within data processing system 200 in FIG. 2. The operating system may be a commercially available operating system such as Microsoft® Windows® (Microsoft and Windows are trademarks of Microsoft Corporation in the United States, other countries, or both), or Linux® (Linux is a trademark of Linus Torvalds in the United States, other countries, or both). An object oriented programming system, such as the Java™ programming system, may run in conjunction with the operating system and provide calls to the operating system from Java™ programs or applications executing on data processing system 200.

Program instructions for the operating system, the object-oriented programming system, the processes of the illustrative embodiments, and applications or programs, including aggregation system 105, are located on one or more storage devices, such as hard disk drive 226 or CD-ROM 230, and may be loaded into a memory, such as, for example, main memory 208, read only memory 224, or one or more peripheral devices, for execution by processing unit 206. Program instructions may also be stored permanently in non-volatile memory and either loaded from there or executed in place. For example, the synthesized program according to an embodiment can be stored in non-volatile memory and loaded from there into DRAM.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in north bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a PDA.

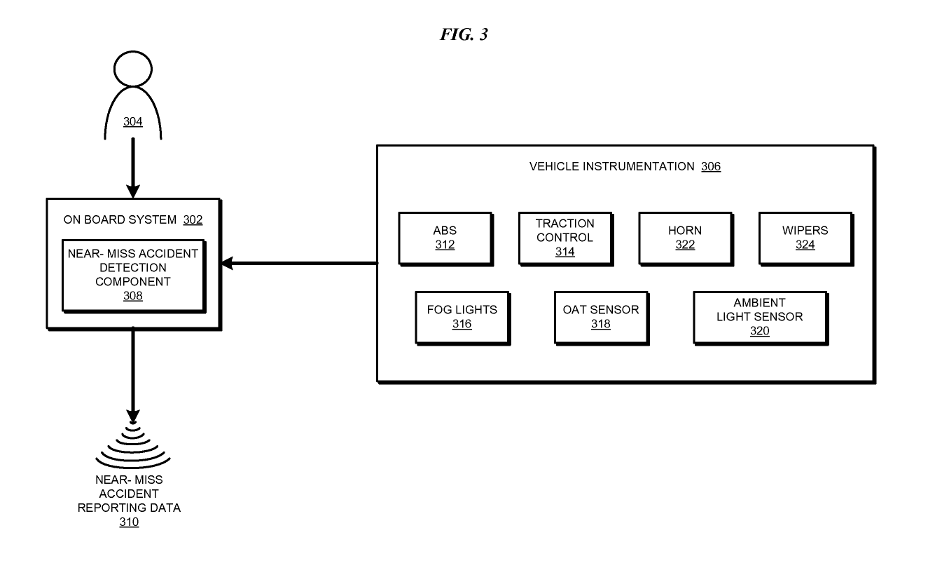

With reference to FIG. 3, this figure depicts a block diagram of a generalized onboard configuration for collaborative near-miss accident reporting in accordance with an illustrative embodiment. Onboard system 302 may be implemented using device 118 in FIG. 1, components of vehicle 122 in FIG. 1, or a combination thereof.

For example, in an embodiment implemented using device 118 in FIG. 1, device 118 comprises some or all components depicted in FIG. 2, and onboard system 302 comprises software including computer usable instructions. The computer usable instructions of the software manifestation of onboard system 302 can be stored in a memory associated with device 118, such as memory 208, solid-state data storage, flash memory, or other suitable substitutes for disk 226 or CD-ROM 230 of FIG. 2. The computer usable instructions of onboard system 302 can be executed by a processing unit associated with device 118, such as processing unit 206 in FIG. 2.

In another embodiment implemented using device 118 in FIG. 1, device 118 comprises some or all components depicted in FIG. 2, and onboard system 302 further comprises one or more hardware components. For example and without implying a limitation thereto, onboard system 302 can include an equivalent of bus 238 for interfacing with a vehicle's instrumentation in a manner analogous to bus 238 interfacing with USB and other ports 232, Audio adapter 216, SIO 236, PCI/PCIe devices 234 in FIG. 2.

In another embodiment implemented using a data processing system embedded in vehicle 122 in FIG. 1, the data processing system embedded in vehicle 122 comprises some or all components depicted in FIG. 2, and onboard system 302 comprises software including computer usable instructions. The computer usable instructions of the software manifestation of onboard system 302 can be stored in a memory associated with the data processing system embedded in vehicle 122, such as memory 208, solid-state data storage, flash memory, or other suitable substitutes for disk 226 or CD-ROM 230 of FIG. 2. The computer usable instructions of onboard system 302 can be executed by a processing unit associated with the data processing system embedded in vehicle 122, such as processing unit 206 in FIG. 2.

In another embodiment implemented using a data processing system embedded in vehicle 122 in FIG. 1, the data processing system embedded in vehicle 122 comprises some or all components depicted in FIG. 2, and onboard system 302 further comprises one or more hardware components. For example and without implying a limitation thereto, onboard system 302 can include an equivalent of bus 238 for interfacing with a vehicle's instrumentation in a manner analogous to bus 238 interfacing with USB and other ports 232, Audio adapter 216, SIO 236, PCI/PCIe devices 234 in FIG. 2.

Onboard system 302 receives into near-miss accident detection component 308 one or more inputs about events transpiring when a hazardous condition is encountered. Onboard system 302 can receive these inputs from operator 304, vehicle instrumentation 306, or a combination thereof. Using these inputs, near-miss accident detection component 308 determines whether the inputs are indicative of a near-miss accident. If the inputs are indicative of a near-miss accident, near-miss accident detection component 308 causes onboard system 302 to transmit near-miss accident reporting data 310 to any number and types of recipients as described herein.

Near-miss accident detection component 308 can, in different embodiments, receive different combinations of inputs for making the determination whether a near-miss accident has occurred. For example, in one embodiment, onboard system 302 receives inputs from vehicle instrumentation 306 that antilock braking system (ABS) 312 was activated and traction control system 314 stabilized a skid. Such inputs can indicate to near-miss accident detection component 308 that the operator swerved to avoid a hazard from debris on the road, and a near-miss accident condition exists.

In another embodiment, onboard system 302 receives inputs from vehicle instrumentation 306 that wipers 324 are active, fog lights 316 are on, ambient light sensor 320 is detecting an illumination level below a threshold, and traction control system 324 is constantly counteracting skids. Such inputs can indicate to near-miss accident detection component 308 that driving surface conditions are probably slippery and therefore suboptimal in the area where the vehicle is presently being operated. In an embodiment, near-miss accident detection component 308 determines that if certain inputs persist for longer than a threshold period, the conditions warrant a near-miss accident report.

Other inputs from vehicle instrumentation 306, such as whether horn 322 is used, a reading from outside air temperature (OAT) sensor 318 is below or above a threshold, accelerometers, steering system's position, vehicle stabilization system activation, and many other available instrumentation in modern vehicles, can similarly be used by near-miss accident detection component 308 to determine whether a near-miss accident condition exists. Furthermore, in an embodiment, onboard system 302 can also receive an input from operator 304 into near-miss accident detection component 308, whereby operator 304 indicates that a near-miss accident occurred. Operator 304 can provide the input by direct or indirect means, such as by vocalizations, facial expressions, or changes in other physiological response such as perspiration, change in heart rate, or change in skin temperature and reflectivity. Near-miss accident detection component 308 can use such operator provided input alone or in combination with inputs from one or more components of vehicle instrumentation 306 to make a near-miss accident determination in an embodiment.

In an embodiment, onboard system 302 outputs raw input data received from operator 304 and components of vehicle instrumentation 306 as near-miss accident reporting data 310. In another embodiment, onboard system 302 processes the inputs, such as by using logic in near-miss accident detection component 308, to convert the input data into some predetermined form or structure, and transmits the converted data as near-miss accident reporting data 310.

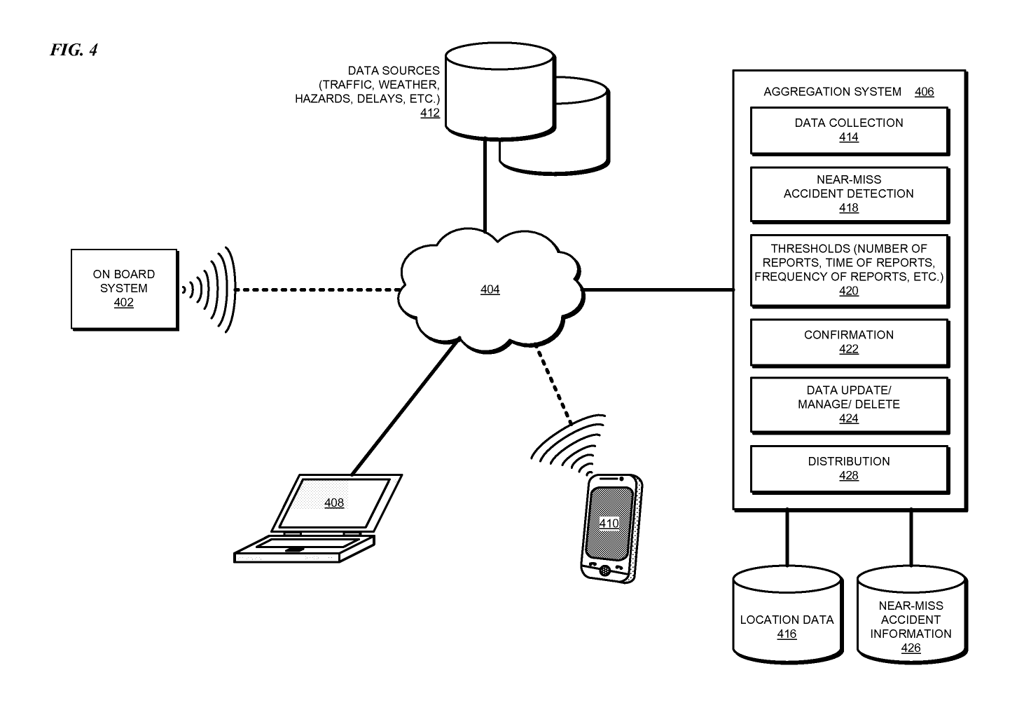

With reference to FIG. 4, this figure depicts a block diagram of an example configuration of an aggregation system for collecting, processing, managing, and distributing near-miss accident information in accordance with an illustrative embodiment. Onboard system 402 is analogous to onboard system 302 in FIG. 3 and network 404 is analogous to network 102 in FIG. 1. Aggregation system 406 is analogous to aggregation system 105 in FIG. 1.

In an embodiment, aggregation system 406 receives near-miss accident data not only from onboard system 402, but also from other sources, e.g., computer 408 and portable device 410, in a crowd-sourced manner. For example, a user may provide a near-miss accident report from computer 408 using a website, such as a social networking website. As another example, a user may provide a near-miss accident report from a portable device 410, such as a smartphone.

In addition to near-miss accident reporting data, aggregation system 406 also receives data from data sources 412. For example, one of data sources 412 can provide traffic advisory information to aggregation system 406. Another example data source 412 can provide weather information. Another example data source 412 can provide known hazardous conditions and delays information to aggregation system 406.

Aggregation system 406 includes data collection component 414 to collect near-miss accident reporting data and other information, such as from sources 408, 410, and 412. Repository 416 provides location information, such as maps, geo-coded locations, and other similar information to aggregation system 406.

Aggregation system 406 further includes near-miss accident detection component 418. Even though inputs to onboard system 402, or perceptions of users of computer 408 or portable device 410, may suggest a near-miss accident condition, whether the conditions at the reported location warrant a distribution of near-miss accident information about that location is a distinct determination at aggregation system 406. For example, a driver of a vehicle may swerve to avoid an animal on the road. While from the driver's perspective, the driver had a near-miss accident, the animal may have crossed the road before another driver encounters the same hazardous conditions. Thus, even though onboard system 402 of the first driver may detect a near-miss accident condition and transmit near-miss accident reporting data to aggregation system 406, aggregation system 406 may not receive any more reports of near-miss accidents from that location, and near-miss accident detection component 418 may conclude that the near-miss accident report from the first vehicle does not warrant the distribution of near-miss accident information about that location.

On the other hand, a driver of a vehicle may swerve to avoid a concrete block that may have fallen from a truck on the road. From the driver's perspective, the driver had a near-miss accident, and the concrete block may remain on the road for a duration such that other drivers encounter the same hazardous conditions. Thus, several onboard systems 402 may detect a near-miss accident condition and transmit near-miss accident reporting data to aggregation system 406. If aggregation system 406 has received above a threshold number of reports of near-miss accidents from that location, near-miss accident detection component 418 concludes that the near-miss accident reports do warrant the distribution of near-miss accident information about that location.

As another example, one instance of onboard system 402 may send near-miss accident reporting data that suggests icing conditions. Aggregation system 406 may not receive additional reports from additional instances of onboard system 402, such as when the location in question experiences sparse traffic. Even though aggregation system 406 receives only one near-miss accident report, data from one or more data sources 412 may suggest to near-miss accident detection component 418 that the conditions at the reported location are indeed icy, and warrant the distribution of near-miss accident information about the location. These examples of the operation of near-miss accident detection component 418 are not intended to be limiting on the illustrative embodiments. Those of ordinary skill in the art will be able to conceive from this disclosure many more ways of combining the available data and making similar determinations, and the same are contemplated within the scope of the illustrative embodiments.

Furthermore, additional logic of near-miss accident detection component 418 may be included in making the determination whether to distribute certain near-miss accident information, target selection for such distribution, or a combination thereof. Using the icing conditions as an example, additional logic of near-miss accident detection component 418 can determine whether the icing is severe enough for all vehicles or only hazardous for lighter than a threshold gross weight vehicles, 2-wheel drive vehicles, or vehicles having certain characteristics. Accordingly, near-miss accident detection component 418 may determine that the near-miss accident information is worthy of selective distribution according to some criteria for selecting the recipients.

Thresholds 420 may be any number of threshold values settable and usable for the operation of near-miss accident detection component 418. For example, one of thresholds 420 may be a threshold number of near-miss accident reports that should be received before near-miss accident information about the location is distributed. Another example threshold in thresholds 420 may be a threshold time window within which such reports should be received, so that the reports can be construed as reporting the same near-miss accident condition and not different conditions at approximately the same location.

Another example threshold in thresholds 420 may be a threshold frequency of near-miss accident reports exceeding which the hazardous conditions at the reported location can be deemed temporary, semi-permanent, or permanent. These example thresholds 420 are not intended to be limiting on the illustrative embodiments. Those of ordinary skill in the art will be able to conceive from this disclosure many more thresholds usable for making similar determinations, and the same are contemplated within the scope of the illustrative embodiments.

Under certain circumstances, near-miss accident detection component 418 may have to obtain additional information to make the determination whether to regard a near-miss accident report as resulting from a condition warranting distribution of near-miss accident information. For example, when two instances of onboard system 402 transmit near-miss accident reports separated by a tolerance time limit beyond a time threshold, the logic in near-miss accident detection component 418 may not be able to ascertain whether the reports pertain to the same near-miss accident condition or different ones. As an example, in this and other circumstances presenting ambiguity in the near-miss accident reports, confirmation component 422 can transmit a message to one or more instances of onboard system 402 to provide additional information about the near-miss accident. For example, in one embodiment, confirmation component 422 transmits a message to an instance of onboard system 402, which prompts a corresponding operator to answer a question or provide additional information. The message and the prompt may take any suitable form depending on the circumstances and the specifics of a particular implementation.

Under other circumstances, near-miss accident detection component 418 may obtain additional information from instances of onboard system 402 to further analyze the conditions under which a near-miss accident occurred. Additional information may then enhance a near-miss accident report for further analysis and future detection of a near-miss accident condition. For example, when two instances of onboard system 402 transmit near-miss accident reports, and the near-miss accident detection component 418 ascertains the reports pertain to the same near-miss accident condition, confirmation component 422 may make a request for data from both instances about route and driving conditions leading up to the near-miss accident. In this way, near-miss accident detection component 418 may correlate certain near-miss accidents with a sequence of conditions and events leading up to the near-miss accident. Near-miss accident detection component 418 may recognize this sequence of events in the future to alert specific drivers of a possible near-miss accident condition.

Data management component 424 is responsible for transforming received near-miss accident reporting data, in conjunction with information from data sources 408, 410, 412, and 416, into near-miss accident information that is distributable to and consumable by various recipients. For example, one transformation process in component 424 may remove identifying information from a near-miss accident report to form near-miss accident information. Another transformation in component 424 may normalize differing formats or contents of various near-miss accident reports to create standardized near-miss accident information about the near-miss accident condition.

Another transformation in component 424 may filter, parse, map, position, or otherwise manipulate the received data to create near-miss accident information so that an interested parent, guardian, or an operator may program an instance of onboard system 402 using the near-miss accident information. Another transformation may add information to near-miss accident report data to form near-miss accident information that is usable by the police for police functions.

In addition to transforming near-miss accident report data into near-miss accident information, component 424 also updates existing near-miss accident information, for example, based on new near-miss accident reports, elapse of time, or reported change in conditions from data sources 408, 410, 412, or 416. If particular near-miss accident information is no longer applicable, should not be distributed, or both, component 424 also deletes or otherwise removes from distribution such near-miss accident information.

The operations of component 424 can be accomplished using repository 426, which stores near-miss accident information. Repository 426 can take any suitable form without limitation within the scope of the illustrative embodiments.

These example operations of data management component 424 are not intended to be limiting on the illustrative embodiments. Those of ordinary skill in the art will be able to conceive from this disclosure many more operations for creating, updating, deleting, or otherwise manipulating near-miss accident information, and the same are contemplated within the scope of the illustrative embodiments.

Distribution component 428 distributes near-miss accident information to instances of onboard system 402, other users, such as those using computer 408 or portable device 410, or any other suitable recipient of the near-miss accident information.

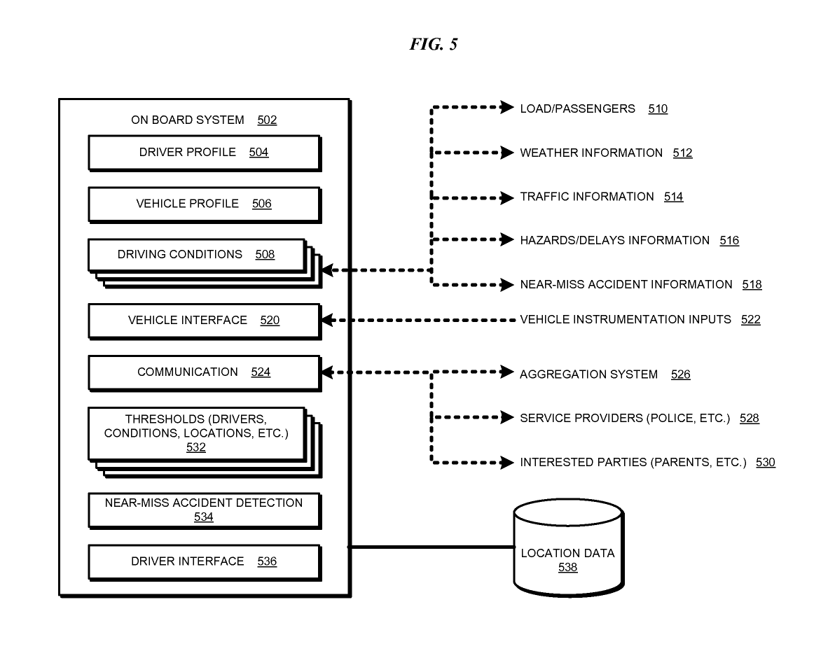

With reference to FIG. 5, this figure depicts a block diagram of an example configuration of an onboard system in accordance with an illustrative embodiment. Onboard system 502 is usable as onboard system 402 in FIG. 4.

An embodiment of onboard system 502 pertains to a surface operated vehicle, such as a car and a driver thereof, without implying a limitation. Onboard system 502 can be adapted for use in aviation, marine, or other environments within the scope of the illustrative embodiments.

Onboard system 502 maintains driver (operator) profile 504. Driver profile 504 is usable for determining whether certain inputs, such as from a vehicle's instrumentation, can be interpreted as resulting from a near-miss accident. For example, antilock brakes responding to a sudden braking for a novice driver may not necessarily indicate a near-miss accident, but panic under the circumstances, whereas antilock brakes responding to a sudden braking for an experienced driver may be indicative of a near-miss accident.

Onboard system 502 maintains vehicle profile 506. Vehicle profile 506 is also usable for determining whether certain inputs, such as from a vehicle's instrumentation, can be interpreted as resulting from a near-miss accident. For example, the traction control system may respond more often in a passenger car than a commercial transport truck. Accordingly, the traction control system responding in a passenger car need not necessarily indicate a near-miss accident, but the traction control system responding in a commercial transport truck may be indicative of a near-miss accident.

Onboard system 502 maintains driving (operating) conditions 508. Driving conditions 508 may include any combination of load or passenger information 510, weather information 512, traffic information 514, known hazards and delays information 516, currently distributed near-miss accident information 518, and other information depending on the implementation. Driving conditions 508 are also usable for determining whether certain inputs, such as from a vehicle's instrumentation, can be interpreted as resulting from a near-miss accident.

For example, the traction control system responding beyond a threshold value on a dry day may not necessarily indicate a near-miss accident, but the traction control system responding beyond a threshold value under rainy conditions may be indicative of a near-miss accident. As another example, the ABS responding at a location may not necessarily indicate a near-miss accident, but the ABS responding at a location for which near-miss accident information is effective may be indicative of a near-miss accident. As another example, sudden braking when carrying children may not necessarily indicate a near-miss accident but only a distraction, but sudden braking when the operator is alone may be indicative of a near-miss accident.

The example driving (operating) conditions 508 are not intended to be limiting on the illustrative embodiments. Those of ordinary skill in the art will be able to conceive from this disclosure many more types of information usable in a similar manner, and the same are contemplated within the scope of the illustrative embodiments.

Vehicle interface component 520 collects inputs 522 from vehicle instrumentation. Communication component 524 enables onboard system 502 to communicate with aggregation system 526 (which is analogous to aggregation system 406 in FIG. 4), service providers 528, such as the police or the fire department, and other interested parties 530, such as parents, guardians, or other observers.

Thresholds 532 may include any number of threshold values settable and usable for the operation of near-miss accident detection component 534. For example, one of thresholds 532 may be a speed threshold set according to the driver's age or experience. When exceeding the speed threshold, a sudden braking action triggers near-miss accident detection component 534 to send a notification or alert including a near-miss accident report to aggregation system 526, service providers 528, interested parties 530, or a combination thereof. As another example, another threshold 532 may be a location threshold set according to the driver's allowed driving area (area restriction). When driving outside the area restriction, certain inputs trigger near-miss accident detection component 534 to send a near-miss accident report, a notification, and/or an alert, to aggregation system 526, service providers 528, interested parties 530, or a combination thereof. These example thresholds 534 are not intended to be limiting on the illustrative embodiments. Those of ordinary skill in the art will be able to conceive from this disclosure many more thresholds usable for making similar determinations, and the same are contemplated within the scope of the illustrative embodiments.

Furthermore, the notifications or alerts may be triggered together with or separate from near-miss accident reports. Using communication component 524, onboard system 502 can send notifications or alerts about an occurrence of a near-miss accident condition to the operator, transmitted to another receiver, such as a parent, responsible individual, or manager. Additionally, communication component 524 can communicate the notifications or alerts in any suitable manner. For example, an operator may be a recipient of a notification (not shown), and may experience vibrations in the steering wheel, reduction in vehicle speed, reduction in radio volume, or a prompt on driver (operator) interface 536. In another case, a manager or a parent of the operator may receive an email, text message, or a phone call containing a notification.

Near-miss accident detection component 534 receives inputs from vehicle interface 520, driver (operator) interface 536, or a combination thereof. Near-miss accident detection component 534 uses the inputs in conjunction with one or more of driver profile 504, vehicle profile 506, driving (operating) conditions 508, and thresholds 532, to determine whether certain inputs should be interpreted as being indicative of a near-miss accident. Near-miss accident detection component 534 also uses location data 538, such as a maps database, in making the determination.

Driver (operator) interface 536 may be any mechanism usable for communicating information to the driver (operator). For example, in one embodiment, driver interface 536 includes a display screen associated with onboard system 502. In another embodiment, driver interface 536 includes a vibration mechanism associated with the controls or seats of the vehicle. In another embodiment, driver interface 536 includes an audio system associated with the vehicle or onboard system 502. Any suitable method of communicating information to or from the operator is usable as driver (operator) interface 536, and the same is contemplated within the scope of the illustrative embodiments.

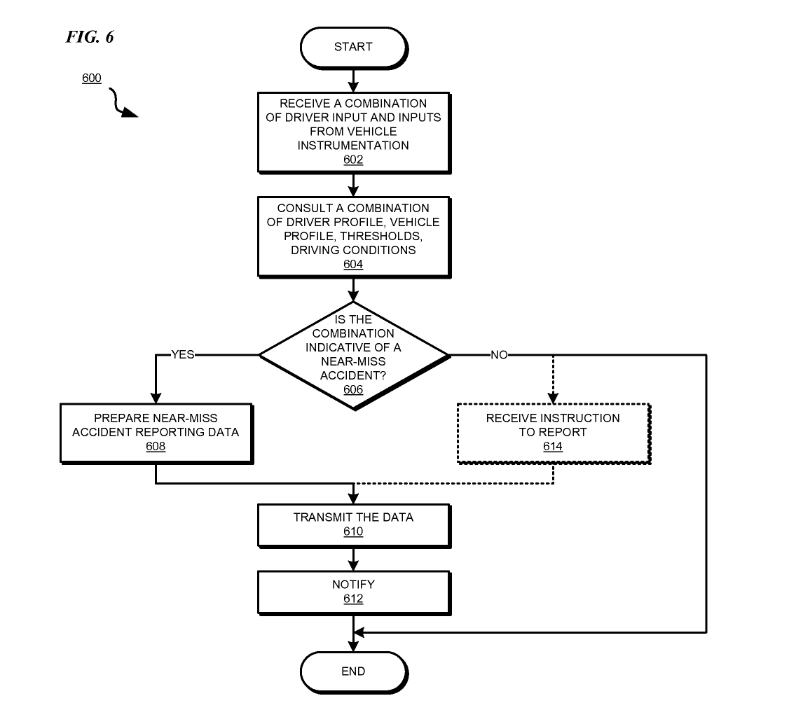

With reference to FIG. 6, this figure depicts a flowchart of an example process of near-miss accident detection in an onboard system in accordance with an illustrative embodiment. Process 600 may be implemented in an onboard system, such as onboard system 502 in FIG. 5.

The onboard system receives a combination of driver (operator) input and inputs from one or more components of a vehicle's instrumentation (block 602). The onboard system consults additional information available to the onboard system, for example, a combination of driver (operator) profile, vehicle profile, driving conditions, thresholds, and location data in conjunction with the inputs of block 602 (block 604).

The onboard system determines whether the combination of the inputs of block 602 and information from block 604 is indicative of a near-miss accident (block 606). If the combination is indicative of a near-miss accident (“Yes” path of block 606), the onboard system prepares near-miss accident reporting data (block 608). The onboard system transmits the data of block 608, such as to aggregation system 406 in FIG. 4, (block 610). Optionally, the onboard system may also notify the operator, another person or entity, or a combination thereof, about an occurrence of a near-miss accident condition (block 612). The onboard system ends process 600 thereafter. In one implementation, the onboard system may return to the starting point of process 600, await further inputs, and repeat the blocks as described herein.

If the combination is not indicative of a near-miss accident (“No” path of block 606), the onboard system may end process 600 thereafter, or optionally, receive an instruction to report a near-miss accident (block 614). For example, an operator may want to force a near-miss accident report under certain circumstances, and may provide additional inputs to the onboard system to effect the creation and transmission of near-miss accident reporting data. Following block 614, the onboard system transmits the near-miss accident data at block 610; the onboard system optionally notifies persons or entities at block 612, and may end thereafter.

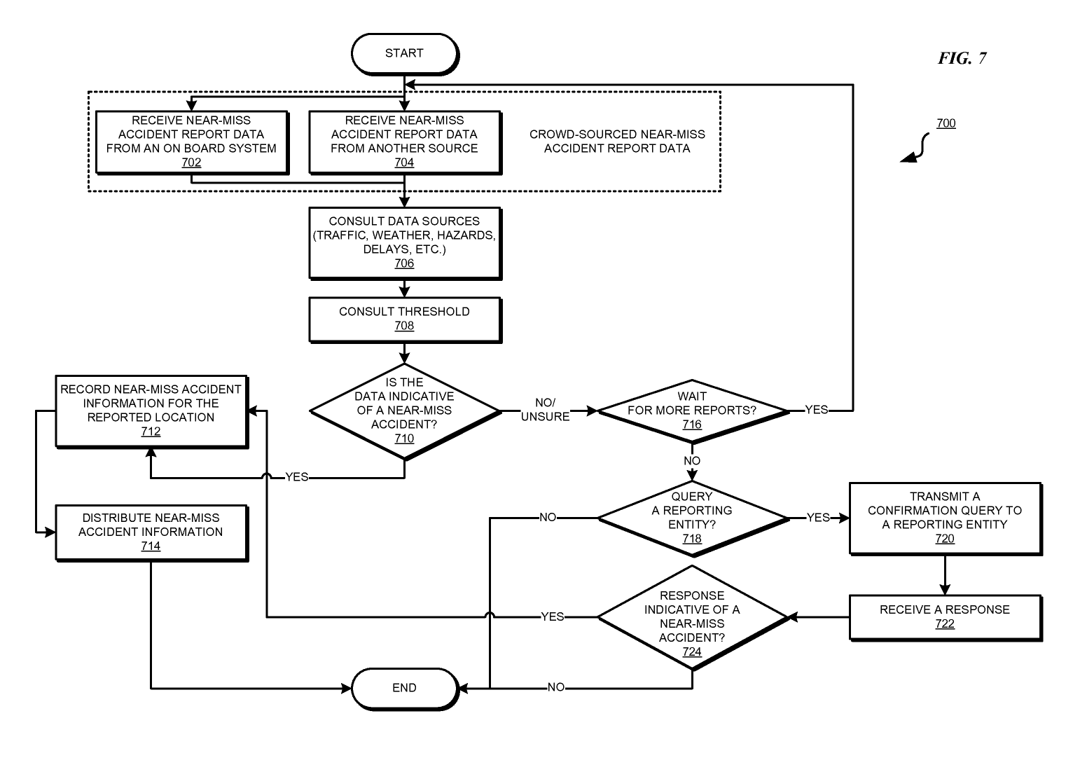

With reference to FIG. 7, this figure depicts a flowchart of an example process of collaborative near-miss accident reporting in accordance with an illustrative embodiment. Process 700 can be implemented in an aggregation system, such as aggregation system 406 in FIG. 4.

The aggregation system receives near-miss accident report data either from an onboard system (block 702), another source, such as a person using a website or a portable device, (block 704), or a combination thereof. Collectively, any source of near-miss accident report data is called a crowd-source, and near-miss accident report data received from a crowd-source is called crowd-sourced near-miss accident report data.

The aggregation system consults other data sources for additional information, such as, for example, any combination of traffic information, weather information, known hazards and delays information, and currently distributed near-miss accident information (block 706). The aggregation system consults one or more threshold values set for determining near-miss accident conditions (block 708).

Using the crowd-sourced near-miss accident report data, information for other sources, and the various thresholds, the aggregation system determines whether the near-miss accident report data is indicative of a near-miss accident (block 710). If the near-miss accident report data is indicative of a near-miss accident (“Yes” path of block 710), the aggregation system records near-miss accident information for the reported location (block 712). The aggregation system distributes the near-miss accident information to instances of onboard system 402, other users, such as those using computer 408 or portable device 410 in FIG. 4, or any other suitable recipient of the near-miss accident information (block 714). The aggregation system ends process 700 thereafter.

If the near-miss accident report data is not indicative of a near-miss accident, or the aggregation system cannot ascertain that the data indicates a near-miss accident (“No/unsure” path of block 710), the aggregation system determines whether to await additional reporting from that location (block 716). If the aggregation system decides to await additional near-miss accident reports (“Yes” path of block 716), the aggregation system returns process 700 to the crowd-sourcing blocks 702 and 704 to wait for additional near-miss accident reports from that location.

If The aggregation system decides not to wait for additional reports (“No” path of block 716), The aggregation system determines whether to query a reporting entity, such as sending a message to the onboard system of block 702 or the source of block 704 (block 718). If the aggregation system decides not to send a query (“No” path of block 718), the aggregation system may end process 700 thereafter or return process 700 to blocks 702 and 704 for crowd-sourcing new near-miss accident report data.

If the aggregation system decides to send a query (“Yes”' path of block 718), the aggregation system transmits a confirmation query to a reporting entity (block 720). The aggregation system receives a response to the query (block 722).

The aggregation system determines whether the response is indicative of a near-miss accident (block 724). If the response is indicative of a near-miss accident (“Yes” path of block 724), the aggregation system proceeds to block 712 and continues there from. If the response is not indicative of a near-miss accident (“No” path of block 724), the aggregation system may end process 700 thereafter or return process 700 to blocks 702 and 704 for crowd-sourcing new near-miss accident report data.

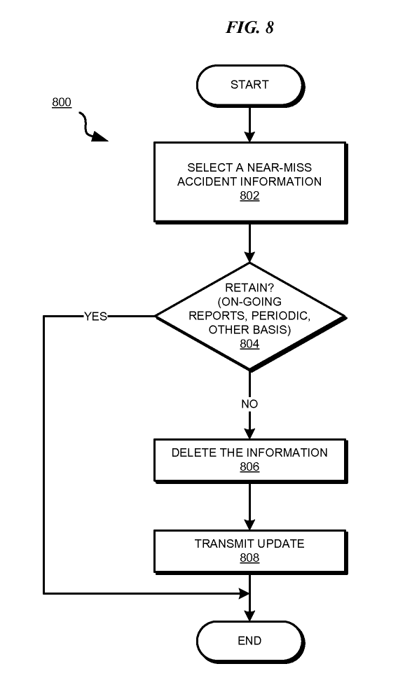

With reference to FIG. 8, this figure depicts a flowchart of an example process of managing near-miss accident information in accordance with an illustrative embodiment. Process 800 can be implemented an aggregation system, such as aggregation system 406 in FIG. 4.

The aggregation system selects an instance of near-miss accident information, such as an instance of near-miss accident information existing in a near-miss accident repository (block 802). The aggregation system evaluates whether to retain the near-miss accident information (block 804). For example, the aggregation system may consider whether on-going near-miss accident reports related to the near-miss accident information instance are being received, whether the near-miss accident information pertains to a hazardous condition that is periodic and likely to occur again according to the periodicity, or whether some other basis exists for retaining the near-miss accident information instance.

If the aggregation system decides to retain the near-miss accident information (Yes” path of block 804), the aggregation system ends process 800 thereafter without affecting the near-miss accident information instance. If the aggregation system determines that the near-miss accident information instance should not be retained (“No” path of block 804), the aggregation system deletes the near-miss accident information instance (block 806). The aggregation system transmits an update to subscribing receivers of near-miss accident information effectively removing the deleted near-miss accident information instance from their consideration (block 808). The aggregation system ends process 800 thereafter.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Thus, a method, system, and computer program product are provided in the illustrative embodiments for collaborative near-miss accident reporting. An embodiment aggregates near-miss accident data from various sources such as government reports, databases, information scavenging, or crowd-sourcing. Using the near-miss accident data obtained in a collaborative manner from various sources in this way, an embodiment advantageously provides information to vehicle operators and other recipients. For example, a GPS device in a recipient's vehicle can re-route the recipient to a safer route using the near-miss accident information from an embodiment.

As another example, a risk of accident at a location can be calculated using the near-miss accident information about the location. For example, a risk factor R can be computed where a higher than a threshold value of R denotes a greater likelihood of a serious accident as compared to the likelihood when the value of R is lower than the threshold. A lower than threshold value of R may also indicate that the particular road or intersection has had relatively few accidents. The value of R may be determined by many factors that go beyond a simple number of accidents. For example, R may be a multidimensional vector that defines a risk based on factors such as number of near-miss accident reports at a location as a function of weather, date, time of day, age of driver, number of occupants in vehicle, the nature of the vehicle, and any other suitable factor.

An embodiment can also allow setting routing thresholds. For example, depending on the near-miss accident information available for locations on a given travel route, a GPS device can be modified to select an alternate travel route if the near-miss accident information meets or exceeds certain criteria. For example, an alternate travel route may be selected if the risk factor R is greater than a threshold on a travel route, but only if the alternate travel route meets certain other criteria or comparative threshold.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable storage device(s) or computer readable media having computer readable program code embodied thereon.

Any combination of one or more computer readable storage device(s) or computer readable media may be utilized. The computer readable medium may be a computer readable signal medium or a computer readable storage medium. A computer readable storage device may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage device would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage device may be any tangible device or medium that can contain, or store a program for use by or in connection with an instruction execution system, apparatus, or device.

Program code embodied on a computer readable storage device or computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN), a wide area network (WAN), or a mobile ad hoc network (MANET), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to one or more processors of one or more general purpose computers, special purpose computers, or other programmable data processing apparatuses to produce a machine, such that the instructions, which execute via the one or more processors of the computers or other programmable data processing apparatuses, create means for implementing the functions/acts specified in the flowchart and/or block diagram block or blocks.

These computer program instructions may also be stored in one or more computer readable storage devices or computer readable media that can direct one or more computers, one or more other programmable data processing apparatuses, or one or more other devices to function in a particular manner, such that the instructions stored in the one or more computer readable storage devices or computer readable medium produce an article of manufacture including instructions which implement the function/act specified in the flowchart and/or block diagram block or blocks.

The computer program instructions may also be loaded onto one or more computers, one or more other programmable data processing apparatuses, or one or more other devices to cause a series of operational blocks to be performed on the one or more computers, one or more other programmable data processing apparatuses, or one or more other devices to produce a computer implemented process such that the instructions which execute on the one or more computers, one or more other programmable data processing apparatuses, or one or more other devices provide processes for implementing the functions/acts specified in the flowchart and/or block diagram block or blocks.

The terminology used herein is for the purpose of describing particular embodiments only and is not intended to be limiting of the invention. As used herein, the singular forms “a”, “an” and “the” are intended to include the plural forms as well, unless the context clearly indicates otherwise. As used herein, a set includes one or more members unless the context indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

What is claimed is:

1. A method for collaborative near-miss accident reporting, the method comprising:
a computer receiving, from a source in a plurality of sources, data relating to a near-miss accident;
the computer determining whether the data relating to the near-miss accident is indicative of an event whose information should be distributed; and
the computer distributing, responsive to the determining being affirmative, near-miss accident information corresponding to the data relating to the near-miss accident.

2. The method of claim 1, further comprising:
the computer manipulating the data relating to the near-miss accident and data from another source to form the near-miss accident information.

3. The method of claim 2, wherein the data from another source comprises second data relating to a second near-miss accident at a location of the near-miss accident.

4. The method of claim 3, wherein the computer receives the data relating to the near-miss accident and the second data relating to the second near-miss accident within a time threshold.

5. The method of claim 1, further comprising:
the computer waiting for second data relating to a second near-miss accident from a location of the near-miss accident;
the computer receiving the second data relating to the second near-miss accident, wherein the determining further includes determining whether the second data relating to the second near-miss accident is also indicative of the event whose information should be distributed.

6. The method of claim 1, further comprising:
the computer querying the source for a confirmation of the near-miss accident; and
the computer receiving an affirmative confirmation responsive to the querying, the distributing being further responsive to the affirmative confirmation.

7. The method of claim 1, wherein the near-miss accident information comprises one of a plurality of near-miss accident information in a repository, wherein the distributing comprises distributing to a set of subscribers, the set of subscribers including at least one of the plurality of sources, further comprising:
the computer determining whether to retain the near-miss accident information for future distribution;
the computer deleting the near-miss accident information from the repository responsive to determining not to retain the near-miss accident information; and
the computer updating the set of subscribers such that a member of the set of subscribers does not use the near-miss accident information for a future purpose.

8. The method of claim 7, wherein the future purpose includes one of (i) a risk factor calculation at the location of the near-miss accident, (ii) a route planning in a Global Positioning System (GPS) device, and (iii) an area restriction for route planning in the GPS device.

9. The method of claim 7, wherein the future purpose includes setting a threshold value in an onboard system, the onboard system being a source in the plurality of sources.

10. The method of claim 1, the determining comprising:
the computer correlating the data relating to the near-miss accident with data from a second data source; and
the computer comparing an aspect of the data relating to the near-miss accident to at least one threshold value, wherein the determining is affirmative if the aspect of the data relating to the near-miss accident as correlated with the data from the second data source exceeds the at least one threshold value.

11. The method of claim 1, wherein the source in the plurality of sources is an onboard system that is onboard a vehicle.

12. The method of claim 1, wherein the data relating to the near-miss accident includes an input from a component of a vehicle's instrumentation.

13. The method of claim 1, wherein the data relating to the near-miss accident includes historical near-miss accident data available in a vehicle, and wherein the receiving includes receiving the historical near-miss accident data.

14. The method of claim 1, wherein the data relating to the near-miss accident includes an input provided by an operator of the vehicle.

15. A computer program product comprising one or more computer-readable tangible storage devices and computer-readable program instructions which are stored on the one or more storage devices and when executed by one or more processors, perform the method of claim 1.

16. A method for collaborative near-miss accident reporting, the method comprising:
a computer in a vehicle receiving a set of inputs from instrumentation in the vehicle;
the computer determining whether the set of inputs is indicative of a near-miss accident; and
the computer transmitting, responsive to the determining being affirmative, data relating to the near-miss accident to an aggregation system.

17. The method of claim 16, further comprising:
the computer processing, responsive to the determining being affirmative, a subset of the set of inputs to form the data relating to the near-miss accident, wherein the data relating to the near-miss accident is in a predetermined format.

18. The method of claim 16, further comprising:
the computer receiving an instruction to report a subset of the set of inputs as being indicative of the near-miss accident, wherein the transmitting is alternatively responsive to receiving the instruction.

19. The method of claim 16, wherein the determining further comprises:
the computer correlating the set of inputs with data from a second data source; and
the computer comparing an input in the set of inputs to at least one threshold value, wherein the determining is affirmative when the input as correlated with the data from the second data source exceeds the at least one threshold.

20. The method of claim 16, further comprising:
the computer notifying, responsive to the determining being affirmative, an operator of the vehicle, wherein the notifying comprises one of (i) vibrating a vehicle control device in the vehicle, (ii) vibrating a surface that is in contact with the operator, and (iii) adjusting a volume of sound within the vehicle.

21. A computer system comprising one or more processors, one or more computer-readable memories, one or more computer-readable tangible storage devices and program instructions which are stored on the one or more storage devices for execution by the one or more processors via the one or more memories and when executed by the one or more processors perform the method of claim 16.

22. A computer program product for collaborative near-miss accident reporting, the computer program product comprising:
one or more computer-readable tangible storage devices;
program instructions, stored on at least one of the one or more storage devices, to receive, from a source in a plurality of sources, data relating to a near-miss accident;
program instructions, stored on at least one of the one or more storage devices, to form a determination whether the data relating to the near-miss accident is indicative of an event whose information should be distributed; and
program instructions, stored on at least one of the one or more storage devices, to distribute, responsive to the determination being affirmative, near-miss accident information corresponding to the data relating to the near-miss accident.

23. A computer system for collaborative near-miss accident reporting, the computer system comprising:
one or more processors;
one or more computer-readable tangible storage devices;
program instructions, stored on at least one of the one or more storage devices for execution by at least one of the one or more processors, to receive, from a source in a plurality of sources, data relating to a near-miss accident;
program instructions, stored on at least one of the one or more storage devices for execution by at least one of the one or more processors, to form a determination whether the data relating to the near-miss accident is indicative of an event whose information should be distributed; and
program instructions, stored on at least one of the one or more storage devices for execution by at least one of the one or more processors, to distribute, responsive to the determination being affirmative, near-miss accident information corresponding to the data relating to the near-miss accident.

24. A computer program product for collaborative near-miss accident reporting, the computer program product comprising:
one or more computer-readable tangible storage devices;
program instructions, stored on at least one of the one or more storage devices, to receive a set of inputs from instrumentation in a vehicle;
program instructions, stored on at least one of the one or more storage devices, to form a determination whether the set of inputs is indicative of a near-miss accident; and
program instructions, stored on at least one of the one or more storage devices, to transmit, responsive to the determination being affirmative, data relating to the near-miss accident to an aggregation system.

25. A computer system for collaborative near-miss accident reporting, the computer system comprising:
one or more processors;
one or more computer-readable tangible storage devices;
program instructions, stored on at least one of the one or more storage devices for execution by at least one of the one or more processors, to receive a set of inputs from instrumentation in a vehicle;
program instructions, stored on at least one of the one or more storage devices for execution by at least one of the one or more processors, to form a determination whether the set of inputs is indicative of a near-miss accident; and
program instructions, stored on at least one of the one or more storage devices for execution by at least one of the one or more processors, to transmit, responsive to the determination being affirmative, data relating to the near-miss accident to an aggregation system.
